(19) United States
(12) Patent Application Publication
(10) Pub. No.: US 2003/0026116 A1
(43) Pub. Date: Feb. 6, 2003

(54) On-vehicle DC-DC converter & method thereof

(76) Inventors: Koichi Ueki, Saitama (JP); Shigenori Kinoshita, Kanagawa (JP); Kenji Tsurumi, Tokyo (JP); Fumito Takahashi, Saitama (JP)

Correspondence Address: ROSSI & ASSOCIATES, P.O. Box 826, Ashburn, VA, 20146-0826, US

(21) Appl. No.: 10/189,278

(22) Filed: Jul. 3, 2002

(30) Foreign Application Priority Data
Jul. 4, 2001 (JP) 2001-202895
Jul. 9, 2001 (JP) 2001-207148

(51) Int. Cl. H02M 3/18

(52) U.S. Cl. 363/60

(57) ABSTRACT

An on-vehicle DC-DC converter prevents radio disturbance in a car radio, while simplifying the filters on the input side and the output side of the DC-DC converter. The on-vehicle DC-DC converter, which converts the voltage of a first DC power supply to the voltage of a second power supply, provides a switching frequency that is obtained by reducing the oscillation frequency of a quartz oscillator and can be set at 135 kHz for use with AM broadcasts having the frequency interval of 10 kHz or set at (n+0.5) times as high as the frequency interval of 9 kHz for use with AM broadcasts having the frequency interval of 9 kHz, between the adjacent AM broadcast waves receivable by a car radio mounted on a vehicle, n being a positive integer.

### BACKGROUND

An electric vehicle or on a hybrid vehicle use a DC-DC converter. Hereinafter, the DC-DC converter for use with an electric vehicle or on a hybrid vehicle will be referred to as the “on-vehicle DC-DC converter.”

Referring to FIG. 3, which illustrates a block diagram of a system configuration of a conventional driving system of an electric vehicle, the driving system includes a main battery 1, an inverter 2, a motor 3 for driving the vehicle, a reduction gear 4, a differential arrangement 5, wheels 6, an auxiliary battery 8, and a DC-DC converter 7 for charging the auxiliary battery 8 from the main battery 1. If necessary, a battery charger 9 can be included. The vehicle body 10 is schematically illustrated. Since the driving system shown in FIG. 3 is well known to those skilled in the art, the detailed description thereof is omitted.

Referring to FIG. 4, which illustrates a block diagram of a system configuration of a typical parallel hybrid driving system of a hybrid vehicle, the same reference numerals as used in FIG. 3 are used to designate the same elements. The parallel hybrid driving system further includes an engine 11, a clutch 12, a speed change gear 13, and a power coupler 14. Since the parallel hybrid driving system shown in FIG. 4 is also well known to those skilled in the art, the detailed description thereof is omitted.

Referring to FIG. 5, which illustrates a block diagram of the circuit configuration of the DC-DC converter 7 shown in FIGS. 3 and 4, the charging system for charging the auxiliary battery 8 shown in FIGS. 3 and 4 will be described. Such DC-DC converter 7 needs to be electrically insulating type as the voltage of the main battery is 50 V or higher. The circuit of the DC-DC converter 7 shown in FIG. 5 is a forward type circuit including two switching devices, which is one of the insulating type circuits for the switching power supply.

Still referring now to FIG. 5, the DC-DC converter 7 includes an input terminal 71 on the side of the main battery 1, an input filter 72, a voltage smoothing capacitor 73, semiconductor switching devices 74a and 74b, a transformer 75, diodes 74c and 74d for regenerating the exciting current of the transformer 75, a rectifier 76, a current smoothing reactor 77, an output filter 78, and an output terminal 79 on the side of the auxiliary battery 8. FIG. 5 further illustrates a control unit 70a that controls the on and off of the semiconductor switching devices 74a and 74b, a frequency setting unit 70b that sets the switching frequency of the DC-DC converter 7, and an output voltage detector 70c that detects the output voltage of the DC-DC converter 7.

FIG. 6 shows the wave forms explaining the operation of the DC-DC converter of FIG. 5. In FIG. 6, the wave form (a) represents the on and off of the switching devices 74a and 74b, the wave form (b) the current of the switching devices 74a and 74b, the wave form (c) the current of the current smoothing reactor 77, the wave form (d) the current of the diodes 74c and 74d, and the wave form (e) the current of the voltage smoothing capacitor 73.

Now the operation of the DC-DC converter 7 in FIG. 5 will be described with reference to FIG. 6. In FIG. 6, Ton represents the period during which the switching devices are on, Toff the period during which the switching devices are off, T the switching period of the DC-DC converter 7, and f_{S} the switching frequency of the DC-DC converter 7. The DC-DC converter 7 adjusts the period Ton to control the output voltage thereof.

The current of the voltage smoothing capacitor 73 is an alternating current as represented by the wave form (e) in FIG. 6. The current of the current smoothing reactor 77 includes many ripples as represented by the wave form (c) in FIG. 6. FIG. 6 indicates that the currents flowing on the input side and the output side of the DC-DC converter 7 contain numerous higher harmonics. Since high-frequency voltages and high-frequency currents are generated on the input side and the output side of the DC-DC converter 7, as described above, the filters 72 and 78 are included on the input side and the output side, respectively, to reduce transmission noises.

The electric vehicles and the hybrid vehicles typically mount a car radio in the same manner as fossil fuel driven vehicles. It is highly undesirable for the DC-DC converter, as well as the other on-vehicle power instruments, to cause radio disturbance or interfere with the car radio operation. The above described filters are disposed to reduce the noise so that the DC-DC converter does not cause radio disturbance. The DC-DC converter 7 shown in FIG. 5 conducts switching operations at a fixed frequency of the 100 kHz class, and the on-period of the switching devices thereof is almost constant. The frequencies of the AM broadcast waves, which the car radio receives, operate from the 0.5 MHz to 1.5 MHz class, which is around the tenth higher harmonic frequency of the switching frequency of the DC-DC converter. The switching frequency of the inverter for driving the vehicle or the inverter for the air conditioner is set at around 10 kHz so that the switching frequency does not cause any audible noise. The frequencies of the AM broadcast waves thus exceed the hundredth higher harmonic frequency of the switching frequency of the inverters. Since the inverters described above conduct PWM control to convert a DC voltage to an AC voltage, the on period of the switching devices thereof can change from time to time.

Since the on-vehicle power inverters of switching type generate quite a few switching noises as described so far, each on-vehicle power inverter is provided with countermeasures against switching noises to prevent radio disturbance in the car radio in the vehicle.

Now the AM broadcast band will be described below. Generally, the amplitude of the nth higher harmonic comb-tooth wave is 1/n times as large as the amplitude of the fundamental wave. The frequency of the AM broadcast wave corresponds to the 100th or the higher order harmonic frequency of the switching frequency of the DC-DC converter. Since the amplitude of the higher harmonics wave is 1/100 times or less as large as the amplitude of the fundamental wave, the higher harmonic switching frequency of the DC-DC converter does not cause practical radio disturbance of the AM broadcast wave. But around the 10th higher harmonics of the switching frequency of the DC-DC converter of the 100 kHz class corresponding to the AM broadcast frequency sometimes can cause radio disturbance of the AM broadcast wave. To obviate the radio disturbance of the AM broadcast wave caused by the DC-DC converter, the functions of the input filter and the output filter described above are reinforced to reduce the noises from the input line and the output line.

Now the radio disturbance caused by the high frequency leakage current flowing through the casing of the DC-DC converter via the semiconductor switching devices thereof will be described. When the semiconductor switching devices conduct high frequency switching, the insulation sheets disposed between the switching devices and the casing of the DC-DC converter and the insulators in the switching devices work as capacitors.

FIG. 7 is an equivalent circuit diagram of the configuration around the switching devices of the DC-DC converter 7, representing the insulators between the DC-DC converter and the casing, which is electrically equivalent to the body 10 of the vehicle, as capacitors. In FIG. 7, reference numerals 741a and 741b designate schematic representations of the semiconductor switching devices 74a and 74b. The reference numerals 743a and 743b designate insulation sheets between the casing 10 and the semiconductor switching devices 741a and 741b, which are not insulated. Alternatively, the reference numerals 743a and 743b can designate insulators disposed in the semiconductor switching devices 741a and 741b, which are insulated.

In FIG. 7, a primary winding 744 of the transformer 75, an insulated section 745 of the primary winding 744, and a core 746 of the transformer 75 are shown. Since the primary winding 744 is wound around the core 746, the insulated section 745 is shown with respect to the core 746, which is biased at the potential of the casing 10. An insulator 700a insulating the positive side (P side) of the main circuit line from the casing and an insulator 700b insulating the negative side (N side) of the main circuit line from the casing are also shown in FIG. 7.

FIG. 8 schematically shows the changes of the potentials of the constituent elements in FIG. 7 caused by the on and off of the switching devices 741a and 741b. In FIG. 8, Ed represents the voltage between P and N in FIG. 7. The curve (a) in FIG. 8 represents the on and off of the switching devices 741a and 741b , the line (b) the potential of the point \mathring{1} in FIG. 7 with respect to the casing potential, the line (c) the potential of the point \mathring{5} in FIG. 7, the curve (d) the potential of the point \mathring{2} in FIG. 7 with respect to the casing potential, the curve (e) the potential of the point \mathring{4} in FIG. 7 with respect to the casing potential, and the line (f) the potential of the point \mathring{3} in FIG. 7. The line (f) represents the potential of the central portion of the primary winding 744 not changing with respect to the casing potential. As FIG. 8 indicates, the potentials of the points \mathring{2} and \mathring{4} represented by the curves (d) and (e) change abruptly with respect to the casing potential with the on and off of the semiconductor switching devices 741a and 741b.

The behaviors of the leakage currents flowing via the insulators (capacitors 743a and 743b in FIG. 7) will be described below with reference to FIG. 9. FIG. 9 is another equivalent circuit diagram of the configuration around the switching devices of the DC-DC converter of FIG. 7 describing the behaviors of the leakage currents flowing via the insulators (the capacitors in FIG. 7). Since the potentials of the points \mathring{2} and \mathring{4} change abruptly with the on and off of the semiconductor switching devices 741a and 741b with respect to the casing potential as represented by the curves (d) and (e) in FIG. 8, currents flow through the insulators (capacitors 743a and 743b ). The current iₐ a shown in FIG. 9 is a current that leaks to the capacitor 743a with the on and off of the semiconductor switching device 741a. The current i_{b} is a current that leaks to the capacitor 743b with the on and off of the semiconductor switching device 741b. Since the leakage currents flow to the casing 10 (as shown by the current i_{c} in FIG. 9), a potential difference is formed on the casing 10. The potential difference formed on the casing 10 can further cause radio disturbance of the AM broadcast.

Now the AM broadcast and the radio disturbance of the AM broadcast caused by the switching of the DC-DC converter will be described below. The AM broadcast is a broadcast that modulates the amplitude of a certain high frequency signal (carrier wave) with a voice frequency signal (modulation signal) to obtain a broadcast wave and reproduces the voice signal by receiving and demodulating the broadcast wave on the receiving side. The voice signal superimposed on the high frequency signal is provided with certain frequency characteristics, adjusted for the human auditory sensitivity.

FIG. 10 shows the frequency characteristics of the voice signal superimposed on the high frequency signal. In FIG. 10, F_{L} is the lower limit frequency of the voice frequency, usually around 70 Hz, and F_{H} is the upper limit frequency, usually around 5 kHz. Since the voice signal, which the frequency thereof is lower than F_{L} or higher than F_{H}, is not demodulated, noises caused outside the frequency range of F_{L} and F_{H} by the switching operation do not pose any problem.

FIG. 11 describes the field strengths of the AM broadcast frequencies and the strengths of the noises caused by the switching operation of the DC-DC converter in the same area. In FIG. 11, F₍₎, F₊₁, F₊₂, . . . , F₊ₙ, F₋₁, F₋₂, . . . , F₋ₙ designate adjacent AM broadcast frequencies. The frequency interval between F₀ and F₊₁, F₊₁, and F₊₂, and so on is specified. The frequency interval is 9 kHz in Japan and 10 kHz in North America. The adjacent broadcast frequencies used practically in the same area are separated from each other widely enough so as not to cause radio interference. When the frequency F₀ is broadcasted, the frequencies F₊₁, F₊₂, . . . , F₋₁, F₋₂, . . . are not broadcasted but the frequencies F₊ₙ and F₋ₙ are broadcasted in the same area.

The field intensities of the broadcast frequencies F₍₎, F₊ₙ, and F₋ₙ, are represented by P₍₎, P₊ₙ, and P₋ₙ, in FIG. 11. The frequency F_{N} in FIG. 11 is n times as high as the switching frequency of the DC-DC converter, where n is an integer. When the frequency F_{N} is within the frequency range of F_{L} and F_{H}, the frequency F_{N} causes noise against the AM broadcast. The noise field intensity is represented by P_{N}. The noise, whose frequency is F_{N}, is caused by the switching operation of the DC-DC converter and by the high-frequency leakage current due to the insulators around the semiconductor switching devices.

For preventing radio disturbance of the AM broadcast when the frequencies are allocated as shown in FIG. 11, it is necessary (1) to reduce the noise field intensity P_{N} as much as possible, and (2) to adjust the frequency difference ΔF between the AM broadcast frequency F₀ and the noise frequency F_{N} so that the noise frequency F_{N} is outside the frequency range of F_{L} and F_{H}.

For reducing the noise field intensity P_{N} it is effective to reinforce the input filter and the output filter and to reinforce the electrical insulation between the semiconductor switching devices and the casing. However, the countermeasures described above increase the cost, the size, and the weight of DC-DC converter. Therefore, adjustment of the frequency difference ΔF is employed in addition to the reduction of the noise field intensity P_{N} Moreover, the oscillator circuit in the frequency setting unit 70b of the conventional DC-DC converter 7 shown in FIG. 5 includes a resistor and a capacitor (R and C). Since the time constant of the R and C circuit changes with the variation of the environmental temperature of the DC-DC converter 7, the oscillation frequency changes, causing a switching frequency change.

FIGS. 12(a) and 12(b) describe the radio disturbances of the AM broadcast caused by the temperature change. In FIG. 12(a), no radio disturbance of the AM broadcast is created at the temperature T₁, at which the frequency difference ΔF₁, is wide enough and the frequency F_{N1} which is n times as high as the switching frequency (where n is an integer), is well outside the frequency range of F_{L} and F_{H}. In FIG. 12(b), radio disturbance of the AM broadcast is formed at the temperature T₂, at which the frequency difference ΔF₂ is narrower than the frequency difference ΔF₁, and the frequency F_{N2}, which is n times as high as the switching frequency (where n is an integer), is within the frequency range of F_{L}and F_{H}.

Therefore, an on-vehicle DC-DC converter that does not cause any radio disturbance of the AM broadcast, has been eagerly sought. Moreover, it is necessary to select an appropriate DC-DC converter provided with the countermeasures against radio disturbance for the carrier frequency interval of 9 kHz or 10 kHz considering the country in which the vehicle is used. The management of at least two kinds of DC-DC converters and the selection of one kind of DC-DC converter depending on the relevant country are very complicated and troublesome.

Accordingly, there is a need for an on-vehicle DC-DC converter that obviates the problems described above, in particular for preventing radio disturbance of the AM broadcast. The present invention addresses this need.

### SUMMARY OF THE INVENTION

The present invention relates to an on-vehicle DC-DC converter for converting the voltage of a first DC power supply to the voltage of a second DC power supply for a vehicle, and a method of reducing AM radio noise in the on-vehicle DC-DC converter.

One aspect of the present invention thus is the on-vehicle DC-DC converter, another aspect of the present invention is a vehicle with the on-vehicle DC-DC converter, and another aspect of the present invention is the method of reducing AM radio noise.

The present on-vehicle DC-DC converter includes a frequency setting means for setting the switching frequency of the DC-DC converter at one of 135 kHz for use with a broadcast frequency interval of 10 kHz and (n+0.5) times as high as 9 kHz for use with a broadcast frequency interval of 9 kHz, between the adjacent AM broadcast waves receivable by a car radio mounted to the vehicle, n being a positive integer. The present vehicle includes the afore described on-vehicle DC-DC converter and a radio having an AM tuner.

In one embodiment, the frequency setting means can set the switching frequency of the on-vehicle DC-DC converter at 139.5 kHz.

The frequency setting means can include a quartz oscillator so that it can reduce the precise oscillation frequency of the quartz oscillator to obtain the switching frequency of the on-vehicle DC-DC converter.

The present method includes providing the on-vehicle DC-DC converter and setting the switching frequency of the DC-DC converter at one of 135 kHz for use with a broadcast frequency interval of 10 kHz and (n+0.5) times as high as 9 kHz for use with a broadcast frequency interval of 9 kHz, between the adjacent AM broadcast waves, n being a positive integer.

### BRIEF DESCRIPTION OF THE DRAWINGS

FIG. 1 is a block circuit diagram of a DC-DC converter according to a first embodiment of the invention.

FIG. 2(a) illustrates the relation between the AM broadcast frequencies and the higher harmonic frequencies of the switching frequency of the DC-DC converter for the broadcast frequency interval of 10 kHz.

FIG. 2(b) illustrates the relation between the AM broadcast frequencies and the higher harmonic frequencies of the switching frequency of the DC-DC converter for the broadcast frequency interval of 9 kHz.

FIG. 3 is a block diagram showing the system configuration of a driving system of a conventional electric vehicle.

FIG. 4 is a block diagram showing the system configuration of a typical parallel hybrid driving system of a conventional hybrid vehicle.

FIG. 5 is a block diagram showing the conventional circuit configuration of the DC-DC converter shown in FIGS. 3 and 4.

FIG. 6 shows wave forms explaining the operation of the DC-DC converter of FIG. 5.

FIG. 7 is an equivalent circuit diagram of the configuration around the switching devices of the DC-DC converter of FIG. 7 representing the insulators between the DC-DC converter and the casing by capacitors, which is electrically equivalent to the body of the vehicle.

FIG. 8 schematically shows the changes of the potentials of the constituent elements in FIG. 7 caused by the on and off of the semiconductor switching devices.

FIG. 9 is another equivalent circuit diagram of the configuration around the switching devices of the DC-DC converter of FIG. 7 describing the behaviors of the leakage currents flowing via the insulators (the capacitors in FIG. 7).

FIG. 10 shows the frequency characteristics of the voice signal superimposed on the high frequency signal.

FIG. 11 describes the field strengths of the AM broadcast frequencies and the strengths of the noises caused by the switching of the DC-DC converter in the same area.

FIGS. 12(a) and 12(b) illustrate the radio disturbances of the AM broadcast caused by temperature change.

### DETAILED DESCRIPTION

Now the invention will be described in detail hereinafter with reference to the accompanied drawing figures, which illustrate the preferred embodiments of the invention.

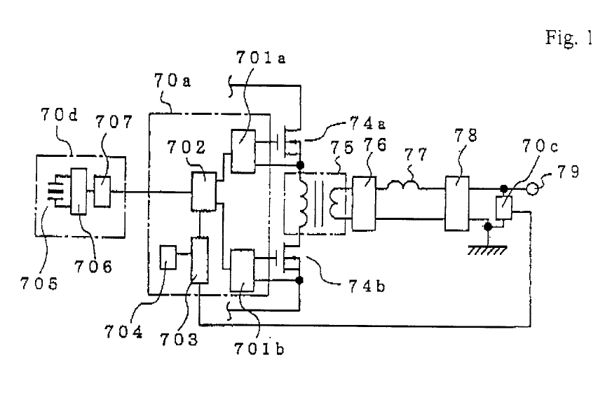

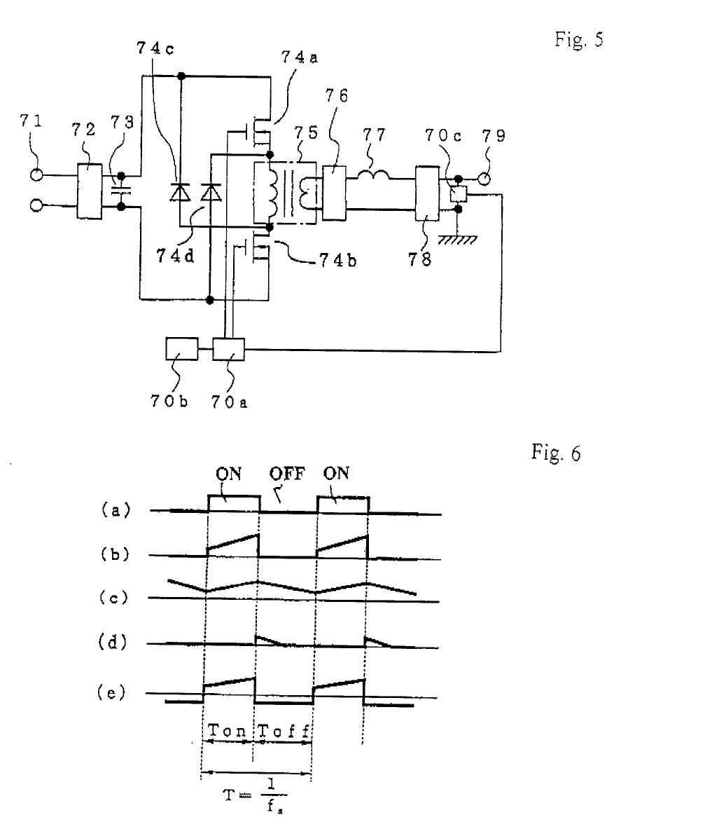

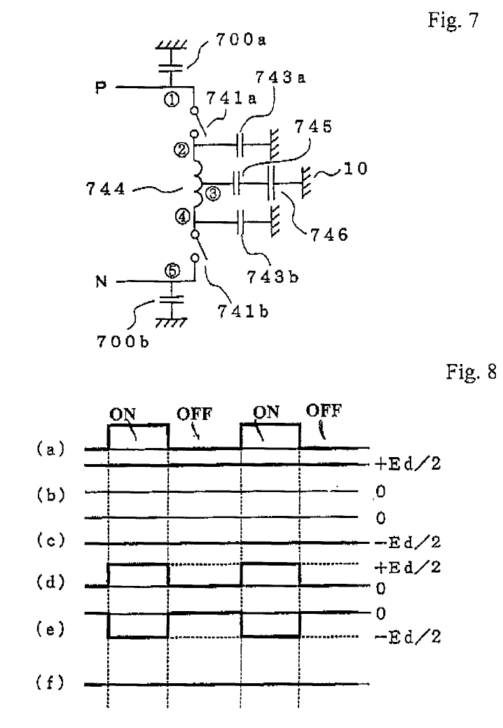

FIG. 1 is a block circuit diagram of an on-vehicle DC-DC converter according to a first embodiment of the invention. In FIG. 1, the same reference numerals as used in FIG. 5 are used to designate the same constituent elements.

The on-vehicle DC-DC converter includes a gate drive circuit 701a that drives a semiconductor switching device 74a, a gate drive circuit 701b that drives a semiconductor switching device 74b, a gate control unit 702 that controls the on period of the switching devices 74a and 74b, and an output voltage regulator 703 that receives a reference output voltage from an output voltage setter 704 and a detected output voltage from an output voltage detector 70c. The output voltage regulator 703 controls the gate control unit 702 so that the reference output voltage and the detected output voltage coincide with each other. The control unit 70a in FIG. 1 has the configuration same as that of the control unit 70a in FIG. 5.

A frequency setting unit 70d is connected to the control unit 70a . The frequency setting unit 70d corresponds to the frequency setting unit 70b in FIG. 5. The frequency setting unit 70d includes a quartz oscillator 705, an oscillator circuit 706 connected to the quartz oscillator 705, and a frequency divider 707 connected to the oscillator circuit 706. When the frequency interval between the adjacent AM broadcast waves is 10 kHz, the frequency divider 707 in the frequency setting unit 70d divides the oscillation frequency fed from the oscillator circuit 706 to convert the oscillation frequency of the quartz oscillator 705 to the frequency of 135 kHz. The frequency setting unit 70d feeds the converted frequency of 135 kHz to the gate control circuit 702 as the switching frequency of the DC-DC converter. In other words, the frequency divider 707 divides the very precise high frequency signal obtained by the quartz oscillator 705 and the oscillator circuit 706 to reduce the very precise high frequency signal to the switching frequency of the DC-DC converter, i.e., 135 kHz.

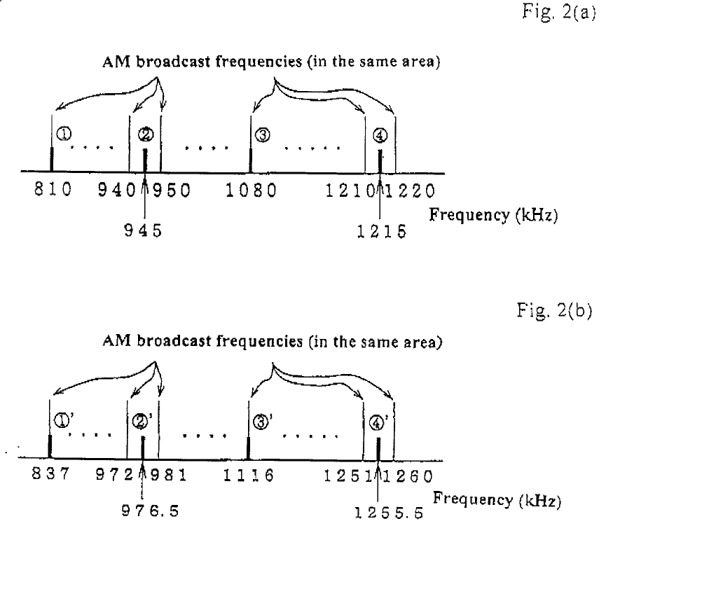

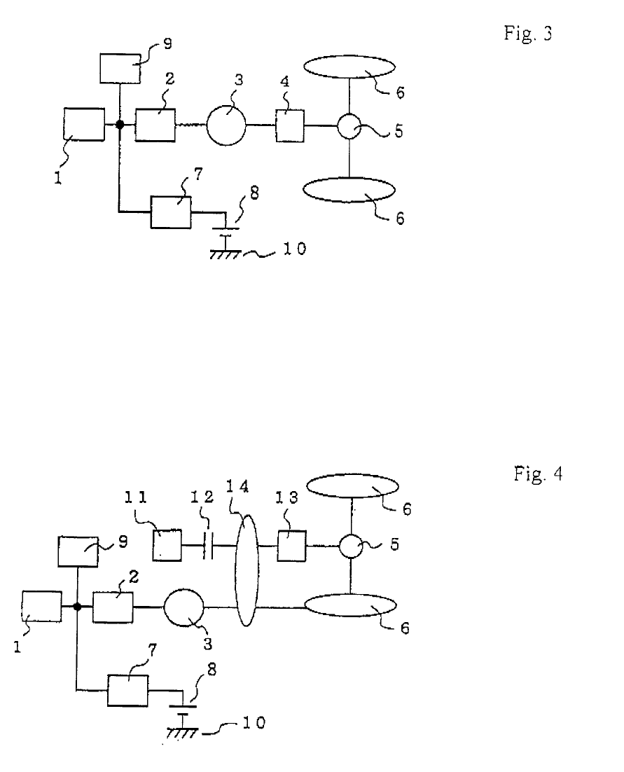

FIG. 2(a) describes the relation between the AM broadcast frequencies (represented by the thin lines in the figure) and the higher harmonic frequencies (represented by the thick lines in the figure) of the switching frequency of the DC-DC converter for the broadcast frequency interval of 10 kHz. When the switching frequency of the DC-DC converter is set at 135 kHz, the frequencies of the even order higher harmonics of the switching frequency (135 kHz) coincide with the AM broadcast frequencies.

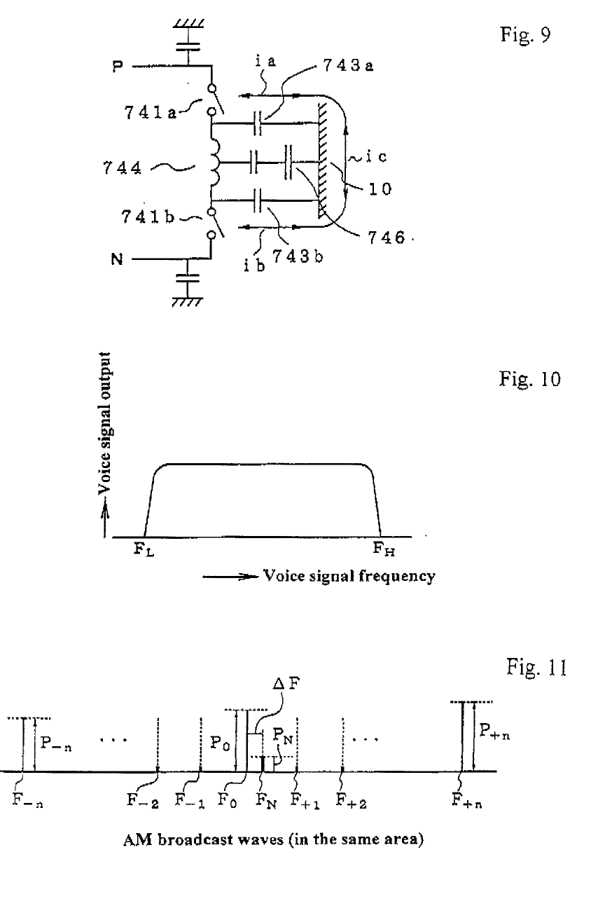

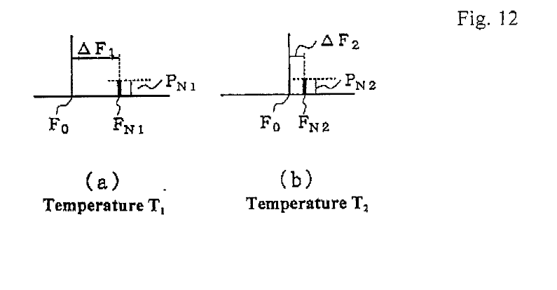

Referring now to FIG. 2(a), the higher harmonic frequency \mathring{1} is 810 kHz, which is the sixth order higher harmonic frequency of the switching frequency 135 kHz and the same with an AM broadcast frequency. The higher harmonic frequency \mathring{3} is 1080 kHz, which is the eighth order higher harmonic frequency of the switching frequency 135 kHz and the same with another AM broadcast frequency. When the AM broadcast frequencies coincide with the even order higher harmonic frequencies, such as the higher harmonic frequencies \mathring{1} and \mathring{3}, of the switching frequency of the DC-DC converter, the frequency difference ΔF described in FIG. 11 is zero. Since the noise frequency F_{N} is outside the frequency range of F_{L} and F_{H} described in FIG. 10 when the frequency difference ΔF is zero, it does not cause any AM radio disturbance.

The odd order higher harmonic frequencies of the switching frequency of 135 kHz are the intermediate frequencies of the adjacent AM broadcast frequencies. In FIG. 2(a), the higher harmonic frequency \mathring{2} is 945 kHz, which is the seventh order higher harmonic frequency of the switching frequency 135 kHz and the intermediate frequency of the adjacent AM broadcast frequencies 940 kHz and 950 kHz. The higher harmonic frequency \mathring{4} is 1215 kHz, which is the ninth order higher harmonic frequency of the switching frequency 135 kHz and the intermediate frequency of the adjacent AM broadcast frequencies 1210 kHz and 1220 kHz.

When the odd order higher harmonic frequencies, such as the higher harmonic frequencies \mathring{2} and \mathring{4}, of the switching frequency of the DC-DC converter are the intermediate frequencies of the adjacent AM broadcast frequencies, the frequency difference ΔF described in FIG. 11 is 5 kHz. Since the frequency difference ΔF of 5 kHz almost coincides with the upper limit frequency of the voice signal superimposed on the AM broadcast waves, it does not cause any radio disturbance.

By setting the switching frequency of the DC-DC converter at 135 kHz as described above, the odd order higher harmonics and the even order higher harmonics of the switching frequency of the DC-DC converter do not cause any radio disturbance against the AM broadcast, even when the frequencies thereof are set at an interval of 10 kHz.

Now the on-vehicle DC-DC converter according to a second embodiment of the invention will be described. Although the circuit configuration of the on-vehicle DC-DC converter according to the second embodiment is the same with that of the DC-DC converter according to the first embodiment, the frequency set by the frequency setting unit 70d according to the second embodiment is different from the frequency of the DC-DC converter according to the first embodiment. According to the second embodiment, the switching frequency of the DC-DC converter 7 is set to be (n+0.5) times as high as the broadcast frequency interval of 9 kHz, that is, 9(n+0.5) kHz (where n is a positive integer).

The DC-DC converter according to the second embodiment will be described below in connection with the positive integer n of 15 in connection with the switching frequency of the DC-DC converter 7 set at (9 kHz)×15.5, which is equal to 139.5 kHz. When the frequency interval between the adjacent AM broadcast waves is 9 kHz, the frequency divider 707 in the frequency setting unit 70d divides the oscillation frequency fed from the oscillator circuit 706 to convert the oscillation frequency to the frequency of 139.5 kHz. The frequency setting unit 70d feeds the converted frequency of 139.5 kHz to the gate control circuit 702 as the switching frequency of the DC-DC converter. In other words, the frequency divider 707 divides the very precise high frequency signal obtained by the quartz oscillator 705 and the oscillator circuit 706 to reduce the very precise high frequency signal to the switching frequency of the DC-DC converter, i.e., 139.5 kHz.

FIG. 2(b) describes the relation between the AM broadcast frequencies and the higher harmonic frequencies of the switching frequency of the DC-DC converter for the broadcast frequency interval of 9 kHz. When the switching frequency of the DC-DC converter is set at 139.5 kHz, the frequencies of the even order higher harmonics of the switching frequency (139.5 kHz) coincide with the AM broadcast frequencies.

Referring now to FIG. 2(b), the higher harmonic frequency \mathring{1}′ is 837 kHz, which is the sixth order higher harmonic frequency of the switching frequency 139.5 kHz and the same with an AM broadcast frequency. The higher harmonic frequency \mathring{3}′ is 1116 kHz, which is the eighth order higher harmonic frequency of the switching frequency 139.5 kHz and the same with another AM broadcast frequency. When the AM broadcast frequencies coincide with the even order higher harmonic frequencies, such as the higher harmonic frequencies \mathring{1}′ and \mathring{3}′ , of the switching frequency of the DC-DC converter, the frequency difference ΔF described in FIG. 11 is zero. Since the noise frequency F_{N} is outside the frequency range of F_{L}and F_{H} described in FIG. 10 when the frequency difference ΔF is zero, it does not cause any AM radio disturbance.

The odd order higher harmonic frequencies of the switching frequency of 139.5 kHz are the intermediate frequencies of the adjacent AM broadcast waves. In FIG. 2(b), the higher harmonic frequency \mathring{2}′ is 976.5 kHz, which is the seventh order higher harmonic frequency of the switching frequency 139.5 kHz and the intermediate frequency of the adjacent AM broadcast frequencies 972 kHz and 981 kHz. The higher harmonic frequency \mathring{4}′ is 1255.5 kHz, which is the ninth order higher harmonic frequency of the switching frequency 139.5 kHz and the intermediate frequency of the adjacent AM broadcast frequencies 1251 kHz and 1260 kHz.

When the odd order higher harmonic frequencies, such as the higher harmonic frequencies \mathring{2}′ and \mathring{4}′ , of the switching frequency of the DC-DC converter are the intermediate frequencies of the adjacent AM broadcast frequencies, the frequency difference ΔF described in FIG. 11 is 4.5 kHz. Since the frequency difference ΔF of 4.5 kHz almost coincides with the upper limit frequency of the voice signal superimposed on the AM broadcast waves, it does not cause any radio disturbance.

By setting the switching frequency of the DC-DC converter at 139.5 kHz as described above, the odd order higher harmonics and the even order higher harmonics of the switching frequency of the DC-DC converter do not cause any radio disturbance against the AM broadcast in which the frequencies thereof are set at an interval of 9 kHz.

Although the DC-DC converter according to the second embodiment of the invention has been described in connection with the switching frequency thereof of 139.5 kHz, 15.5 times as high as the broadcast frequency interval of 9 kHz, the switching frequency of the DC-DC converter set alternatively at 148.5 kHz, 16.5 times as high as the broadcast frequency interval of 9 kHz, does not pose any problem.

The present invention is conducted based on that (1) the AM radio broadcast uses a broadcast wave obtained by modulating the amplitude of a high frequency signal having a certain frequency of around 1 MHz with a voice signal, (2) the upper limit and the lower limit of the voice signal frequency are specified, and (3) the AM radio broadcast detects the broadcast wave and reproduces the voice signals.

According to the first aspect of the invention, the switching frequency of the on-vehicle DC-DC converter can be set at 135 kHz for the frequency interval of 10 kHz between the adjacent AM broadcast waves such that the higher harmonic frequencies of the switching frequency coincide with the AM broadcast frequencies or with the upper limit of the voice signal frequencies. According to the second aspect of the invention, the switching frequency of the on-vehicle DC-DC converter can be set at n+0.5 as high as the frequency interval of 9 kHz between the adjacent AM broadcast waves. The on-vehicle DC-DC converter according to the invention exhibits the following benefits:

(1) The on-vehicle DC-DC converter according to the invention prevents radio disturbance of the AM broadcast or greatly reduces the radio disturbance of the AM broadcast.

(2) The filters disposed on the input side and the output side of the conventional DC-DC converter are simplified, resulting in the reduced costs of the DC-DC converter.

(3) The invention is applicable also to the uninsulated type of DC-DC converters.

(4) The DC-DC converter according to the invention, which is applicable to various vehicles such as an electric vehicle and a hybrid vehicle, contributes greatly to the wide use and the developments of the vehicles.

The present on-vehicle DC-DC converter can be mounted on a vehicle for converting the voltage of a first DC power supply to the voltage of a second DC power supply. The on-vehicle DC-DC converter includes a frequency setting means for setting the switching frequency of the DC-DC converter at 135 kHz for the broadcast frequency interval of 10 kHz or at (n+0.5) times as high as the broadcast frequency interval of 9 kHz, between the adjacent AM broadcast waves receivable by a car radio mounted on the vehicle. For example, the switching frequency of the on-vehicle DC-DC converter can be set at 139.5 kHz for the broadcast frequency interval of 9 kHz between the adjacent AM broadcast waves. The frequency setting means can include a quartz oscillator and reduces the oscillation frequency of the quartz oscillator to obtain the switching frequency of the on-vehicle DC-DC converter.

Given the disclosure of the present invention, one versed in the art would appreciate that there may be other embodiments and modifications within the scope and spirit of the present invention. Accordingly, all modifications and equivalents attainable by one versed in the art from the present disclosure within the scope and spirit of the present invention are to be included as further embodiments of the present invention. The scope of the present invention accordingly is to be defined as set forth in the appended claims.

The disclosures of the priority applications, JP PA 2001-202895 and JP PA 2001-207148, in their entirety, including the drawings, claims, and the specifications thereof, are incorporated herein by reference. 15

What is claimed is:

1. An on-vehicle DC-DC converter for converting the voltage of a first DC power supply to the voltage of a second DC power supply for a vehicle, the on-vehicle DC-DC converter comprising:
a frequency setting means for setting the switching frequency of the DC-DC converter at one of 135 kHz for use with a broadcast frequency interval of 10 kHz and (n+0.5) times as high as 9 kHz for use with a broadcast frequency interval of 9 kHz, between the adjacent AM broadcast waves receivable by a car radio mounted to the vehicle, n being a positive integer.

2. The on-vehicle DC-DC converter according to claim 1, wherein the frequency setting means sets the switching frequency of the on-vehicle DC-DC converter at 139.5 kHz.

3. The on-vehicle DC-DC converter according to claim 1, wherein the frequency setting means comprises a quartz oscillator, and the frequency setting means reduces the oscillation frequency of the quartz oscillator to obtain the switching frequency of the on-vehicle DC-DC converter.

4. The on-vehicle DC-DC converter according to claim 2, wherein the frequency setting means comprises a quartz oscillator, and the frequency setting means reduces the oscillation frequency of the quartz oscillator to obtain the switching frequency of the on-vehicle DC-DC converter.

5. A vehicle comprising:
an on-vehicle DC-DC converter for converting the voltage of a first DC power supply to the voltage of a second DC power supply; and
a radio having an AM tuner,
wherein the on-vehicle DC-DC converter has a frequency setting means for setting the switching frequency of the DC-DC converter at one of 135 kHz for use with a broadcast frequency interval of 10 kHz and (n+0.5) times as high as 9 kHz for use with a broadcast frequency interval of 9 kHz, between the adjacent AM broadcast waves, n being a positive integer.

6. The vehicle according to claim 5, wherein the frequency setting means sets the switching frequency of the on-vehicle DC-DC converter at 139.5 kHz.

7. The vehicle according to claim 5, wherein the frequency setting means comprises a quartz oscillator, and the frequency setting means reduces the oscillation frequency of the quartz oscillator to obtain the switching frequency of the on-vehicle DC-DC converter.

8. The vehicle according to claim 6, wherein the frequency setting means comprises a quartz oscillator, and the frequency setting means reduces the oscillation frequency of the quartz oscillator to obtain the switching frequency of the on-vehicle DC-DC converter.

9. A method of reducing AM broadcast noise in a vehicle with, comprising the steps of:
providing an on-vehicle DC-DC converter for converting the voltage of a first DC power supply to the voltage of a second DC power supply; and
setting the switching frequency of the DC-DC converter at one of 135 kHz for use with a broadcast frequency interval of 10 kHz and (n+0.5) times as high as 9 kHz for use with a broadcast frequency interval of 9 kHz, between the adjacent AM broadcast waves, n being a positive integer.
